(19) United States
(12) Patent Application Publication
(10) Pub. No.: US 2014/0136148 A1
(43) Pub. Date: May 15, 2014

(54) AUTOMATIC DETERMINATION OF DEVICE SPECIFIC INTEROPERABILITY

(71) Applicant: MICROSOFT CORPORATION, Redmond, WA (US)

(72) Inventors: Vasudeva N. Pai, Redmond, WA (US); Andrew W. Lovitt, Redmond, WA (US); Jason R. Farmer, Snohomish, WA (US); Ted E. Dinklocker, Samammish, WA (US)

(73) Assignee: Microsoft Corporation, Redmond, WA (US)

(21) Appl. No.: 13/677,315

(22) Filed: Nov. 15, 2012

(51) Int. Cl. G06F 11/36; G06F 15/177

(52) U.S. Cl. CPC G06F 11/3668; G06F 15/177
USPC 702/186; 709/220

(57) ABSTRACT

Device specific interoperability is provided automatically utilizing remote service and/or cloud computing. Functionality of devices like mobile phones is tested to ensure that the device is properly configured to work with infotainment systems by using the phone to connect with the cloud services.

### BACKGROUND

In a technical context, synergy relates to a collection of different elements working together to produce results greater than those obtainable by any of the elements alone. The term “elements”, as used herein, refers to different kinds of computing devices. The synergies derived from connecting computing devices together results from the relationships between the devices, that is, how they are interconnected. Interoperability between connected devices is required to achieve synergy.

### SUMMARY

A first device, such as but not limited to a home media center or an in-vehicle infotainment system, can be an investigator or an investigating device that investigates a second device such as but not limited to a portable media player or smartphone. The first device and the second device can be connected via a communication channel established by either device. The first device can use a communication channel to investigate (e.g., determine and test) functionality of the second device. Information concerning functionality of the second device can be uploaded to a third device such as a remote server (e.g., in “the cloud”). Profile information such as a configuration report for the second device can be collected by the first device and sent to a third device. Configuration information for the second device can be received from the third device and can be stored on the first device. The first device can dynamically create a device driver for the second device.

The third device can receive information from an investigating device (a device of a first type) concerning an investigated device (a device of a second type), aggregate information about the device of the second type from a plurality of devices of the first type and can provide this information to a query initiated by a device of the first type.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings:

FIG. 1 illustrates an example of a system 100 that automatically determines device specific interoperability in accordance with aspects of the subject matter described herein;

FIG. 2 illustrates an example of a method 200 that automatically determines device specific interoperability in accordance with aspects of the subject matter disclosed herein; and

FIG. 3 is a block diagram of an example of a computing environment in accordance with aspects of the subject matter disclosed herein.

### DETAILED DESCRIPTION

### Overview

Some computing devices such as but not limited to home media centers and in-vehicle infotainment systems are created with a contemplated lifetime in the ten year range while other devices such as but not limited to mobile computing devices (e.g., smartphones, tablets, portable media players, etc.) have a much shorter lifespan. This means, for example, that when a smartphone is connected to an in-vehicle infotainment system or an MP3 player is connected to a home media center, the smartphone and the MP3 player may have been manufactured years after the in-vehicle infotainment (IVI) system or the home media center. The infotainment system or the home media player thus may not be able to interact correctly with the smartphone or the MP3 player. Similarly, different versions of portable devices are developed and the information on the IVI or home media center can rapidly become outdated.

To address this situation, currently, testing of interoperability between these types of devices occurs at a development location. Periodically an update to the device database may be sent to the manufacturer of the one of the computing devices (e.g., an infotainment system manufacturer). It is left to the manufacturer of the computing device to update the outdated information on their computing devices with the new device (e.g., mobile phone) information. Device information can include device specific configuration settings and software updates and so on.

In accordance with aspects of the subject matter disclosed herein, an automatic online procedure to test for functionality of computing devices is described. The automatic online procedure can allow the computing devices to be properly configured to work with other computing devices whose files include outdated information. When different types of computing devices are connected, a connection to a server can be established. Functionality of the investigated computing device can be queried and testing results for the investigated computing device can be uploaded to the server. Connection to the server can be made through the Internet, voice (via a phone call), text (short message service (SMS)), etc.

### Automatic Determination of Device Specific Interoperability

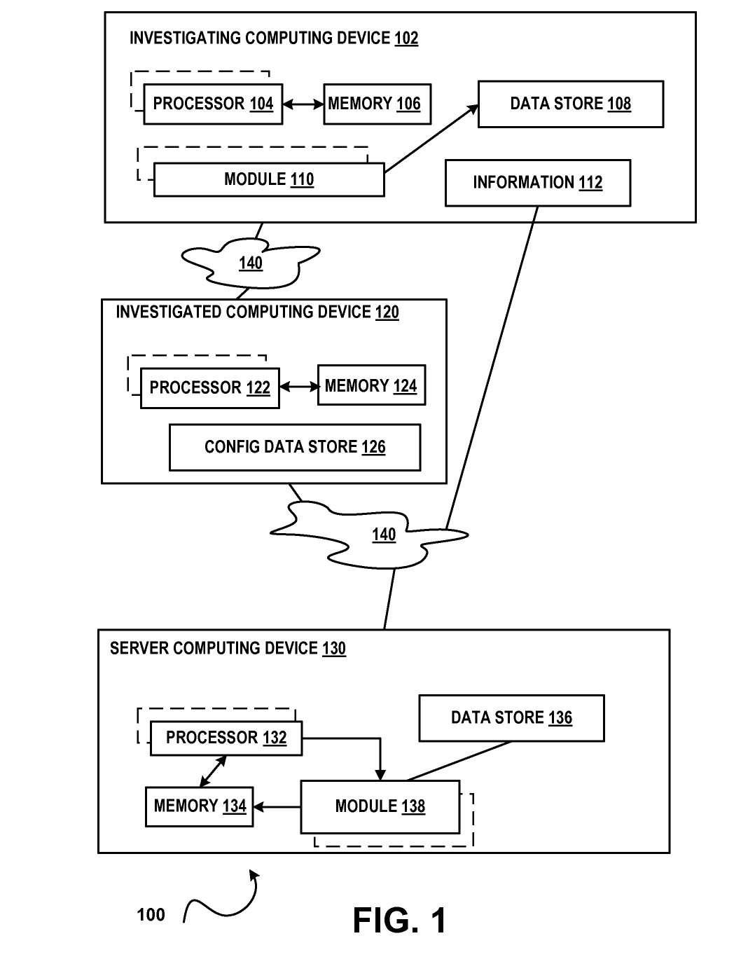

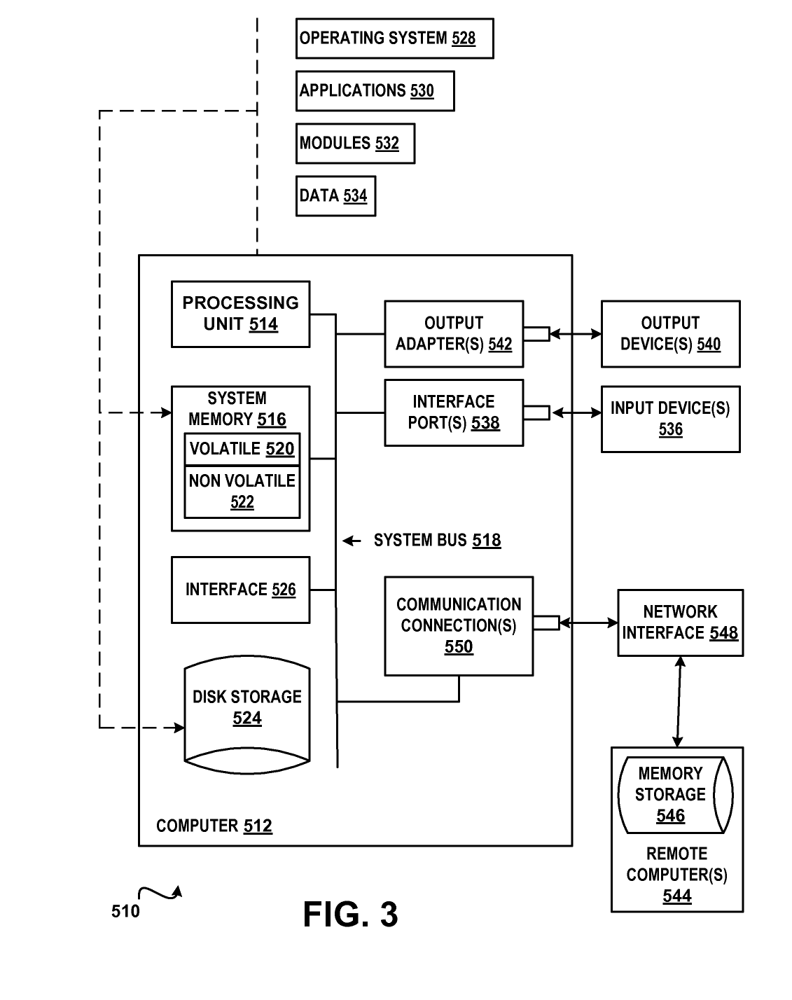

FIG. 1 illustrates a block diagram of an example of a system 100 that automatically determines device specific interoperability utilizing cloud and remote services in accordance with aspects of the subject matter described herein. All or portions of system 100 may reside on one or more computers or computing devices such as the computers described below with respect to FIG. 3. System 100 or portions thereof may be provided as a stand-alone system or as a plug-in or add-in. System 100 or portions thereof may be incorporated within a vehicle's infotainment system, within a home media center, etc. Some of the computers of system 100 may operate in a “cloud” computing environment and/or a “cloud” storage environment in which computing services are not owned but are provided on demand. For example, the server computer described below may be on multiple devices/systems dispersed in a networked cloud, the device configuration data store described below may be stored on the same or on other devices within the cloud, and the fixed or host computing device described below may configure the display on other cloud device(s)/system(s).

System 100 can include any combination of one or more of the following: a first type of device comprising one or more investigating computing devices, a second type of device comprising one or more investigated computing devices and a third type of device comprising one or more servers or server computing devices such as but not limited to a server computer in the cloud. System 100 can include any combination of one or more components or elements of the following: elements of a first type of device comprising one or more investigating computing devices, elements of a second type of device comprising one or more investigated computing devices and/or elements of a third type of device comprising one or more servers or server computing devices such as but not limited to a server computer in the cloud. Devices in system 100 can be connected via a network such as network 140.

An investigating computing device can be a client device such as investigating computing device 102. Investigating computing device 102 can include one or more processors such as processor 104, etc., a memory such as memory 106, a device data store (such as but not limited to a device database) such as device datastore 108 and one or more modules such as module 110, etc. that investigate and perform testing on the second type of device. Information about the second type of device can be collected, including information about the behavior of the second type of device, information characterizing the second type of device and so on. Information about the second type of device can be stored in a data store such as device datastore 108. Information such as information 112 can be transmitted to the server computing device via the investigating computing device or via the investigated computing device. Investigating computing device 102 can be an in-vehicle infotainment system (IVI), a home media center, a wireless speaker system, an in-home telephone system that uses Bluetooth to “replicate” a mobile phone to a home phone system, a peripheral device (such as a mouse or a game controller) that needs to communicate to a host device or any other investigating computing device, etc. Investigating computing device 102 can investigate characteristics such as profile information about another kind of device.

An investigated computing device such as investigated computing device 120 can include one or more processors such as processor 122, etc., a memory such as memory 124, and a device configuration data store such as device configuration data store 126. An investigated computing device 120 can be investigated by an investigating computing device 102. When connected to investigating computing device 102, investigated computing device 120 may expose a set of capabilities to investigating computing device 102. An investigated computing device can be a host device. An investigated computing device can be a mobile computing device such as a laptop computer, notebook computer, smartphone or other mobile phone, tablet, portable media players or the like.

A server computing device such as server computing device 130 can include one or more processors such as processor 132, etc., a memory such as memory 134, an investigated computing device data store such as data store 136 and/or a module or modules such as module 138, etc. that when loaded into the memory 134 enables the server computing device 130 to receive data on behaviors and characteristics of host computing devices, can keep a count of how many computing devices of a particular make and model exhibit the behaviors, can aggregate the data, can analyze the data and/or can provide this data to developers who can generate updates for the computing devices' behaviors. A module or modules such as module 138, etc. when loaded into the memory 134 can enable the server computing device 130 to provide data on behaviors and characteristics of host computing devices to investigating computing devices such as investigating computing device 102.

The developers can prioritize and/or develop updates and push the updates back to the remote server computing device in the cloud. A module or modules such as module 138, etc. when loaded into the memory 134 can enable the server computing device 130 to provide configuration data associated with behaviors and characteristics of host computing devices to investigating computing devices such as investigating computing device 102. The investigating computing device can get the updates deployed to it by the server computing device. The server computing device 130 can generate updates on its own. The server computing device can be a remote server including but not limited to a phone bank, a device bank, etc.

In operation, when a host computing device is connected to a client computing device, a way that the two different types of computing devices can communicate can be determined. For example, the computing devices may communicate via Bluetooth, USB, MTP (Media Transfer Protocol), IEP, NFC (Near Field Communication), DLNA (Digital Living Network Alliance, WiFi, HTTP (HyperText Transport Protocol), etc. After a communication channel is established between the computing devices, the functionality of one of the computing devices such as for example, investigated computing device 120, can be tested by the other computing device.

For example, suppose a mobile phone is Bluetooth-enabled. An IVI may send various AT (attention) commands to the mobile phone to determine if the mobile phone supports text messaging, how the mobile phone communicates its call status, if the mobile phone supports call hold, and so on. The IVI can create configuration information such as a profile on how the particular mobile phone responds to these interrogations. The IVI may have expectations of how calls will proceed and can build a behavior record for the mobile phone computing device that details what is working and what is not working and can send this report to the remote server computing device. There can be various ways to perform specific functionality. The particular way a specific functionality is performed may be based on device specific settings. For example, a particular IVI may not turn on a WiFi hotspot functionality while another IVI may turn it on based on a particular user-specific setting. Alternatively, the IVI may not turn on the WiFi hotspot because it does not have the inherent capability to do so.

Another example is a mobile computing device that does or does not support tethering based on user preferences or based on the provisioning of the service that the computing device has. Tethering means sharing the data connection through a protocol such as PAN (Personal Area Network). When the investigated computing device 120 is connected to the investigating computing device 102, functionality of both the investigated computing device 120 and the investigating computing device 102 can be used to test functionality of the investigated computing device 120. Some investigated computing devices may not implement certain types of functionality at all. Functionality information for particular investigated computing devices may be stored in a data store or database such as device datastore 108 on the investigating computing device. Information concerning how to access a particular investigated computing device, variations peculiar to a particular investigated computing device (e.g., misformed headers, lack of proper responses, etc.) can be included in the database or data store on the investigating computing device.

Many communication protocols for computing devices include data that identifies the make and model of the computing device. The identity information can be used to provide indications of the functionality of an investigated computing device. Moreover, the investigating computing device may make assumptions about the configuration of the investigated computing device based on the identity information. Problems can arise when identity information is incorrect. Identity information can be incorrect for various reasons including but not limited to hardware failure. In this case the investigating device may not have any knowledge of the investigated device's make and model and therefore have no idea how to utilize the investigated device. In accordance with aspects of the subject matter disclosed herein, functionality of an investigated computing device is detected automatically (e.g., programmatically without human intervention). The investigated computing device can be automatically identified. Channel information can be characterized automatically and applied to the investigating device.

A third party (e.g., server computing device 130) can be contacted using the communication capabilities of either the investigating or investigated computing device to investigate interoperability of the different computing devices. The acoustic gain of a phone call made by a mobile phone computing device can be tested. The round trip delay of a communication to and from a remote server can be measured. The SMS profile or algorithm which results in the fastest and most reliable communication through text can be determined. Other information can include:
how to get music (streaming or otherwise) from the investigated computing device
how to play video from the investigated computing device
how to write files to the investigated computing device
discover communication protocol quirks
determine cellular channel type (GSM (Global System for Mobile Communications, CDMA (Code Division for Multiple Access, etc.).

The information received from the third party can be used to determine the identity of the investigated computing device, including a version or release number of the software on the investigated computing device. The information received can be used to update the capabilities reported for the investigated computing device as stored in the data store on the investigating computing device.

The investigating computing device can direct the investigated computing device to play or record particular audio and video signals which can help to identify characteristics of the investigated computing device. For example, the investigated computing device can play a known noisy audio signal. The third party (e.g., server) can listen to the data to enable a comparison between the received signal and the sent signal to quantify audio quality changes. The cellular network over which the signal was sent can be identified. The investigating computing device can receive a file from the server to enable the investigating computing device to know what to expect when testing certain functionality of the investigated computing device.

Device drivers can be dynamically created from information garnered from the investigation to add or remove functionality, compile modified source code, adjust registry settings, etc. to improve the connection experience for that particular computing device.

Suppose for example, a new smartphone is connected to an IVI. When the smartphone is first connected, the IVI can search for configuration information for the smartphone in the IVI database. Suppose configuration information for the smartphone is found in the onboard database of the IVI. The IVI may then use the smartphone to call a dial-up server. The system can then send a set of known waveforms (e.g., audio waveforms) to the remote server through a telephone line. The remote server can analyze the received data because the investigating computing device knows what was sent. This can be done by sending a known sequence to the remote server, connecting to the server by Wifi, or connecting to the server via SMS or other communication protocol. The server can analyze this data and send back device specific settings. The device-specific settings can be integrated into the IVI's data store and can be used whenever that smartphone is connected to the IVI. The IVI can use the settings when a phone from the same manufacturer, model, network, etc. is connected to help inform the implementation of the new device. For example, suppose one party has a particular phone of a type that is also used by another party, the first and second party sharing an investigating computing device. Suppose the first party has successfully connected his/her phone to the investigating computing device. When the second party connects his/her phone to the system the system can use any information the system has from the first party to inform the usage of the phone of the second party.

The investigating computing device can present a dialog which asks to connect to the remote server to optimize the connectivity experience, enabling the user to control whether or not the server is accessed. The equipment manufacturer settings of the computing device or user specific settings can override presentation of the dialog.

Suppose a smartphone test attempts to write audio files to a smartphone but the operation failed and caused an IVI program error. The error report can be sent automatically to the remote server to help the IVI manufacturer identify and correct malfunctions in the IVI programming. Error report sending can be subject to device and/or user policy.

Suppose an investigated computing device such as a Bluetooth enabled mobile phone is connected to an investigating computing device such as a laptop. A text (e.g., SMS) message can be sent using the Message Access Profile (MAP) protocol, by using an HFP (hands free profile) port and AT commands or by using a dedicated Serial Port (SPP)+AT commands. Suppose the phone first tries to send the SMS message through MAP to a dial-up server. When the dial-up server receives the SMS it can send a message back to the phone. The message can be a phone call, SMS, internet message, etc. The paired phone can then send more messages to get statistics on the method. If successful, the MAP profile can be used to communicate through SMS. If this methodology fails, the phone can try to send the SMS message using an HFP port and AT commands and so on.

Suppose a user connects a new phone to an IVI. Suppose the phone implements a hands-free profile through Bluetooth. When the phone is connected to the IVI, the IVI can make a call to a remote server. The IVI can then send known sound files through the phone call to the server. The server can compute various parameters of the phone call audio and network like spectral tilt or distortion, gain settings, whether echo cancellation and noise suppression is disabled on command etc. and can send these computations back to the IVI. The IVI can compensate for these parameters to make sure the phone call sends good data to the far end. The remote server can also send signals which help characterize the channel. The IVI can call a number of servers to collect statistics which have different characteristics (location, network, etc.) to get average and specific statistics.

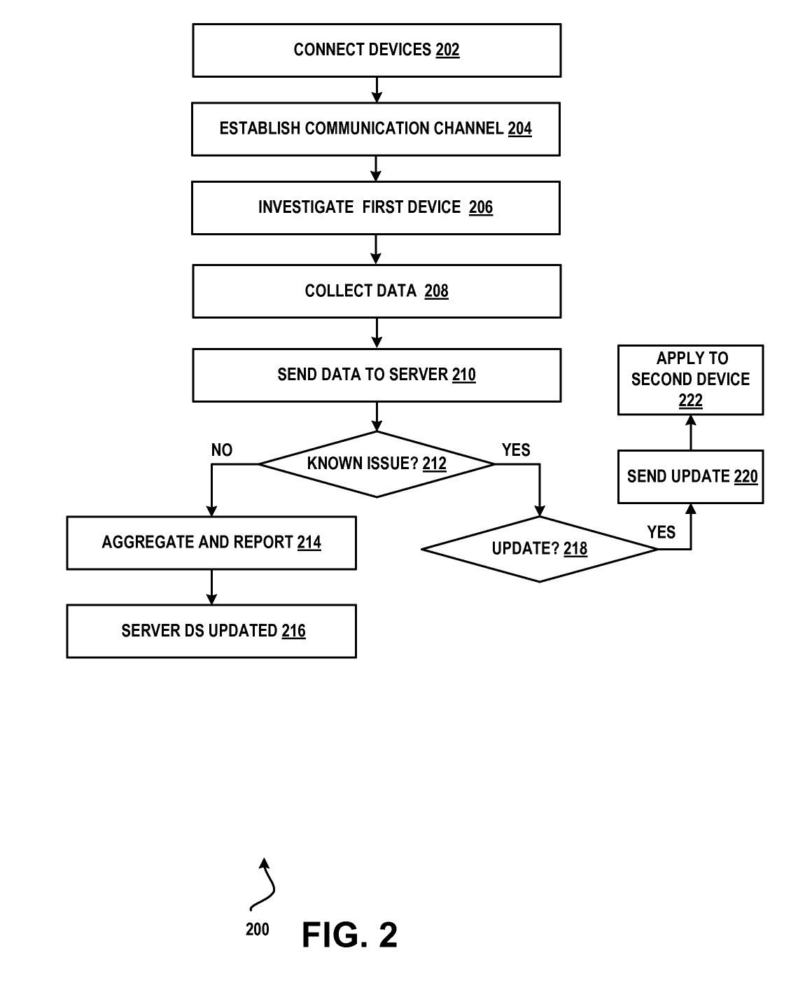

FIG. 2 illustrates a method 200 that can automatically determine device specific interoperability in accordance with aspects of the subject matter described herein. The method described in FIG. 2 can be practiced by a system such as but not limited to the one described with respect to FIG. 1. While method 200 describes a series of operations that are performed in a sequence, it is to be understood that method 200 is not limited by the order of the sequence. For instance, some operations may occur in a different order than that described. In addition, one operation may occur concurrently with another operation. In some instances, not all operations described are performed.

At operation 202 a host and a client device can be connected. A client device can be an investigating device as described more fully above. A host device can be an investigated device as described more fully above. At operation 204 a communication channel can be established. At operation 206 the investigating device can interrogate the investigated device and at operation 208 can collect data about interoperability between the host device and the client device. At operation 210 the collected data can be sent to the server. The server can receive the data. At operation 212 the server can determine if the issue is known. If the issue is not known, the server can aggregate the data and report the data to developers to help them create updates at operation 214. At operation 216 the server data store can be updated with the developer's updates. If at operation 212 the issue is known, at operation 218 the server data store can be searched for an update. If an update is found, the update can be pushed to the host device at operation 220. At operation 222 the update can be provided to the client device.

### Example of a Suitable Computing Environment

In order to provide context for various aspects of the subject matter disclosed herein, FIG. 3 and the following discussion are intended to provide a brief general description of a suitable computing environment 510 in which various embodiments of the subject matter disclosed herein may be implemented. While the subject matter disclosed herein is described in the general context of computer-executable instructions, such as program modules, executed by one or more computers or other computing devices, those skilled in the art will recognize that portions of the subject matter disclosed herein can also be implemented in combination with other program modules and/or a combination of hardware and software. Generally, program modules include routines, programs, objects, physical artifacts, data structures, etc. that perform particular tasks or implement particular data types. Typically, the functionality of the program modules may be combined or distributed as desired in various embodiments. The computing environment 510 is only one example of a suitable operating environment and is not intended to limit the scope of use or functionality of the subject matter disclosed herein.

With reference to FIG. 3, a computing device in the form of a computer 512 is described. Computer 512 may include at least one processing unit 514, a system memory 516, and a system bus 518. The at least one processing unit 514 can execute instructions that are stored in a memory such as but not limited to system memory 516. The processing unit 514 can be any of various available processors. For example, the processing unit 514 can be a graphics processing unit (GPU). The instructions can be instructions for implementing functionality carried out by one or more components or modules discussed above or instructions for implementing one or more of the methods described above. Dual microprocessors and other multiprocessor architectures also can be employed as the processing unit 514. The computer 512 may be used in a system that supports rendering graphics on a display screen. In another example, at least a portion of the computing device can be used in a system that comprises a graphical processing unit. The system memory 516 may include volatile memory 520 and nonvolatile memory 522. Nonvolatile memory 522 can include read only memory (ROM), programmable ROM (PROM), electrically programmable ROM (EPROM) or flash memory. Volatile memory 520 may include random access memory (RAM) which may act as external cache memory. The system bus 518 couples system physical artifacts including the system memory 516 to the processing unit 514. The system bus 518 can be any of several types including a memory bus, memory controller, peripheral bus, external bus, or local bus and may use any variety of available bus architectures. Computer 512 may include a data store accessible by the processing unit 514 by way of the system bus 518. The data store may include executable instructions, 3D models, materials, textures and so on for graphics rendering.

Computer 512 typically includes a variety of computer readable media such as volatile and nonvolatile media, removable and non-removable media. Computer readable media may be implemented in any method or technology for storage of information such as computer readable instructions, data structures, program modules or other data. Computer readable media include computer-readable storage media (also referred to as computer storage media) and communications media. Computer storage media includes physical (tangible) media, such as but not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices that can store the desired data and which can be accessed by computer 512. Communications media include media such as, but not limited to, communications signals, modulated carrier waves or any other media which can be used to communicate the desired information and which can be accessed by computer 512.

It will be appreciated that FIG. 3 describes software that can act as an intermediary between users and computer resources. This software may include an operating system 528 which can be stored on disk storage 524, and which can allocate resources of the computer 512. Disk storage 524 may be a hard disk drive connected to the system bus 518 through a non-removable memory interface such as interface 526. System applications 530 take advantage of the management of resources by operating system 528 through program modules 532 and program data 534 stored either in system memory 516 or on disk storage 524. It will be appreciated that computers can be implemented with various operating systems or combinations of operating systems.

A user can enter commands or information into the computer 512 through an input device(s) 536. Input devices 536 include but are not limited to a pointing device such as a mouse, trackball, stylus, touch pad, keyboard, microphone, voice recognition and gesture recognition systems and the like. These and other input devices connect to the processing unit 514 through the system bus 518 via interface port(s) 538. An interface port(s) 538 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 518. Other devices and/or systems or devices such as remote computer(s) 544 may provide both input and output capabilities.

Computer 512 can operate in a networked environment using logical connections to one or more remote computers, such as a remote computer(s) 544. The remote computer 544 can be a personal computer, a server, a router, a network PC, a peer device or other common network node, and typically includes many or all of the elements described above relative to the computer 512, although only a memory storage device 546 has been illustrated in FIG. 3. Remote computer(s) 544 can be logically connected via communication connection(s) 550. Network interface 548 encompasses communication networks such as local area networks (LANs) and wide area networks (WANs) but may also include other networks. Communication connection(s) 550 refers to the hardware/software employed to connect the network interface 548 to the bus 518. Communication connection(s) 550 may be internal to or external to computer 512 and include internal and external technologies such as modems (telephone, cable, DSL and wireless) and ISDN adapters, Ethernet cards and so on.

It will be appreciated that the network connections shown are examples only and other means of establishing a communications link between the computers may be used. One of ordinary skill in the art can appreciate that a computer 512 or other client device can be deployed as part of a computer network. In this regard, the subject matter disclosed herein may pertain to any computer system having any number of memory or storage units, and any number of applications and processes occurring across any number of storage units or volumes. Aspects of the subject matter disclosed herein may apply to an environment with server computers and client computers deployed in a network environment, having remote or local storage. Aspects of the subject matter disclosed herein may also apply to a standalone computing device, having programming language functionality, interpretation and execution capabilities.

The various techniques described herein may be implemented in connection with hardware or software or, where appropriate, with a combination of both. Thus, the methods and apparatus described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing aspects of the subject matter disclosed herein. As used herein, the term “machine-readable storage medium” shall be taken to exclude any mechanism that provides (i.e., stores and/or transmits) any form of propagated signals. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system comprising:
an investigating computing device comprising at least one processor and a memory connected to the at least one processor;
a module that when loaded into the memory causes the at least one processor to:
investigate a computing device, the investigating computing device comprising a client computing device and the investigated computing device comprising a host computing device;
query the investigated computing device regarding functionality of the investigated computing device;
test the functionality of the investigated computing device based on information received from the investigated computing device;
store the information received from the investigated computing device on the investigated computing device; and
store the results of testing the functionality of the investigated computing device.

2. The system of claim 1, wherein the first device is an infotainment system, a home media center, a wireless speaker system, an in-home telephone system, or a peripheral device.

3. The system of claim 1, wherein the second device is a smartphone, a media player, a personal computer, a laptop computer, a notebook or a mobile phone.

4. The system of claim 1, wherein a communication channel established between the investigating computing device and the investigated computing device comprises a wireless communication channel, a Bluetooth communication channel. a WiFi communication channel, a wireless USB communication channel, a wired communication channel, an MTP (Media Transfer Protocol) communication channel, an IEP communication channel, a NFC (Near Field Communication) communication channel, a DLNA (Digital Living Network Alliance communication channel, DTMP or an HTTP (HyperText Transport Protocol) communication channel.

5. The system of claim 4, wherein the established communication channel is used to send information associated with the investigated computing device to the server computing device.

6. The system of claim 5, wherein the information associated with the investigated computing device comprises configuration information associated with the investigated computing device.

7. The system of claim 1, wherein the investigating computing device sends configuration information associated with the investigated computing device to a server computing device in the cloud.

8. The system of claim 1, wherein the investigating computing device receives information concerning the investigated computing device from a server computing device.

9. The system of claim 1, wherein the investigating computing device dynamically creates a device driver for the investigated computing device.

10. A method comprising:
sending by a server computing device configuration information for a computing device investigated by an investigating computing device to the investigating computing device, the configuration information comprising aggregated configuration information for a plurality of devices of a same make and model as the investigated computing device.

11. The method of claim 10, further comprising:
receiving at the server computing device from an investigating computer device, information associated with a computing device investigated by the investigating computer device.

12. The method of claim 11, wherein the received information associated with the investigated computing device is aggregated with information received from a plurality of computing devices of the same make and model as the investigated computing device.

13. The method of claim 12, wherein the aggregated information is analyzed to find errors or discover implementation shortcomings or to provide prioritizing information for errors.

14. The method of claim 11, wherein a protocol used by the investigating computer device identifies a make and model of the investigated computing device.

15. The method of claim 10, further comprising creating a dynamic device driver for the investigated computing device based on the aggregated information.

16. A computer readable storage medium comprising computer readable instructions that when executed by at least one processor cause the at least one processor to:
receive at a server computing device information from an investigating computer device, the received information associated with a computing device investigated by the investigating computer device; and
send by a server computing device, configuration information for a computing device investigated by an investigating computing device to the investigating computing device, the configuration information comprising analyzed, aggregated configuration information for a plurality of devices of a same make and model as the investigated computing device.

17. The computer-readable storage medium of claim 16, comprising further computer readable instructions that when executed by the at least one processor cause the at least one processor to:
aggregate the information associated with the computing device investigated by the investigating computer device with information received from a plurality of computing devices of a same make and model as the investigated computing device.

18. The computer-readable storage medium of claim 16; comprising further computer readable instructions that when executed by the at least one processor cause the at least one processor to:
identify a make and model associated with the investigated computing device.

19. The computer-readable storage medium of claim 16; comprising further computer readable instructions that when executed by the at least one processor cause the at least one processor to:
analyze the aggregated information to find errors, discover implementation shortcomings or to provide prioritizing information for errors.

20. The computer-readable storage medium of claim 16; comprising further computer readable instructions that when executed by the at least one processor cause the at least one processor to:
push the aggregated information to a developer location.
